(19) United States
(12) Patent Application Publication
(10) Pub. No.: US 2003/0031456 A1
(43) Pub. Date: Feb. 13, 2003

(54) Video recorder with improved control system

(76) Inventor: Peter Vogel, Faulconbridge NSW (AU)

Correspondence Address: FISH & RICHARDSON, PC, 4350 LA JOLLA VILLAGE DRIVE, SUITE 500, SAN DIEGO, CA, 92122, US

(21) Appl. No.: 10/181,241

(22) PCT Filed: Jan. 12, 2001
(86) PCT No.: PCT/AU01/00027

(30) Foreign Application Priority Data
Jan. 13, 2000 (AU) PQ 5060

(51) Int. Cl. H04N 9/79

(52) U.S. Cl. 386/35

(57) ABSTRACT

The present invention relates to video recording apparatus and in particular video recorders incorporating improved user interface (6) and control means. A video recorder comprising recording means (1), tuning means (5), a controller (3) adapted to control the recording means and interface means adapted to communicate commands to and from said controller. The commands include commands to interrogate the operational state of the video recorder. Operational states include, inter alia, tuner frequency: transport mode such as recording, playing or stopped: and current position within the recording media, for example a timecode, elapsed time or time remaining. The commands can also include commands to interrogate the memory within the video recorder. information may thereby be discovered remotely, for example the time, date, channel and duration values corresponding to events that have been set for unattended recording. Further the commands include commands to control the positioning of the recording and reproducing heads of the video recorder; commands to place the recording means of the video recorder into a recording condition, a replaying condition, a forward advancing condition, a reverse advancing condition, a position seeking condition, a pause condition or a stop condition and commands to tune the tuner to a particular frequency or channel.

### FIELD OF THE INVENTION

The present invention relates to video recording apparatus and in particular video recorders incorporating improved user interface and control means.

### BACKGROUND OF THE INVENTION

Video recorders are found in most homes in every industrialised country. Most commonly these utilise cassettes of video tape as the recording medium and are known as VCRs (Video cassette recorders). Recently, video disk recorders have been developed which offer many advantages over VCRs. The most popular video disk system is known as DVD (Digital Versatile Disk). Video recorders utilising hard disks as the recording mechanism are also available and offer certain advantages.

From the user's point of view, both VCRs and DVDs are operationally similar. Most commonly, they are used to record television programs for viewing at a more convenient time. In this patent specification, the term VCR will be used to refer to a video recorder of any type. Domestic VCRs generally incorporate television tuning means, so that a program can be recorded without the need to use an external television tuner.

The task of setting up a newly-installed VCR has been found to be daunting for many users with low technical abilities. Accordingly, much effort has been devoted to making the setting-up task progressively more user-friendly. One major advance to this end has been the widespread introduction of so-called “on-screen display” or OSD. A VCR equipped with OSD provides a text-based display at its video output which is used to guide the user through the setting up process by providing menus of choices and prompts. The user utilises the VCR's remote control buttons to select options and set values, such as the mapping between channel preset numbers and actual tuner frequencies, and for setting the clock/calendar.

The OSD is also useful after installation for setting operational parameters, for example setting the timer for unattended recording.

In spite of the best efforts of VCR designers, the average user is still unable to fully utilise their VCR due to the complexity of setting it up fully and correctly.

Another limitation of prior art VCRs is that the remote control facility has only restricted functionality. While the remote controller can generally be used to change channels, adjust volume, start and stop tape playing, and several other functions, there are certain limitations on what can be achieved with the simple arrangement of prior-art VCRs. For example, in some cases it is desirable for certain VCR functions to be controlled from a personal computer (PC). Attempts have been made to enable such ability by providing an infra-red transmitter which is interfaced to the PC, however such systems have been of limited value because prior-art VCR remote control interfaces offer such limited functionality. One major limitation is that the remote control interface is unidirectional, that is, the remote controller can send commands to the VCR but it cannot receive data or commands from the VCR. Such reverse-direction data is required for certain advanced control features. For example, if the remote controlling PC wishes to turn on the VCR and the power control function is a toggle function, it may need to know whether the VCR is already turned on. Similarly, before issuing a “pause” command, it is necessary to determine whether the VCR is already paused and act accordingly, otherwise the command may not have the desired effect. Another benefit of being able to receive data from the VCR at the controller is the ability to interrogate the tape counter or other indication of how much recording time is available on the recording media. This reverse direction has previously not been considered beneficial, since the user can ascertain these operational conditions by inspection of the VCR's display panel if remote control is being activated by a person. However when the remote control function is being performed by a computer, or by a person at a remote location who cannot see the VCR being controlled, such feedback is essential for full utilisation of the VCR.

### SUMMARY OF THE INVENTION

Accordingly, it is an object of this invention to provide a video recorder including improved means for controlling configuration and operation.

It is another object to provide a video recorder including improved remote control means.

Another object is to provide a video recorder including an interface through which all user controls can be affected and through which the operational condition of the video recorder can be determined by a remote device.

It is yet a further object to provide a video recorder interfaced to a personal computer.

According to one aspect of the present invention, there is provided a video recorder comprising recording means, tuning means, a controller adapted to control the recording means and interface means adapted to communicate commands to and from said controller.

In a particular embodiment, the commands include commands to interrogate the operational state of the video recorder. Operational states include, inter alia, tuner frequency; transport mode such as recording, playing or stopped; and current position within the recording media, for example a timecode, elapsed time, or time remaining.

In another embodiment, the commands include commands to interrogate the memory within the video recorder. Information may thereby be discovered remotely, for example the time, date, channel and duration values corresponding to events that have been set for unattended recording.

In another embodiment, the commands include commands to control the positioning of the recording and reproducing heads of the video recorder.

In yet another particular embodiment, the commands include commands to place the recording means of the video recorder into a recording condition, a replaying condition, a forward advancing condition, a reverse advancing condition, a position seeking condition, a pause condition or a stop condition.

In yet another particular embodiment, the commands include commands to tune the tuner to a particular frequency or channel.

In yet another particular embodiment, the commands include commands to select one of a plurality of program sources as the recording source.

In yet another particular embodiment, the commands include commands to set the clock or calendar within the video recorder to a particular time or date.

In yet another particular embodiment, the commands include commands to set the unattended-recording timer to a particular time, date, duration and channel.

In yet another particular embodiment, the commands include commands to cause the on-screen display system of the video recorder to display certain text or images.

According to an extension of this inventive concept, the video recorder includes means for storing a log of usage, including, for example, which channels were viewed at what times. This log can be downloaded from the video recorder for analysis of viewing habits or for pay-per-view charging. In other embodiments, this logging function is provided by the PC or a remote computer via the internet.

According to another aspect of the present invention, there is provided a video recorder comprising recording means, a controller adapted to control the recording means and interface means adapted to communicate commands to and from said controller, wherein said commands enable setting and interrogation of memory values within the video recorder for the purpose of configuration.

In another aspect, the invention comprises a video recorder, a personal computer, and interface means adapted to provide bi-directional communication between said video recorder and said personal computer. In a particular embodiment of the invention according to this aspect, the video recorder is not equipped with user operating controls, all operating control being effected by interaction with a graphical user interface provided by the personal computer. In such an embodiment, control and configuration signals from the personal computer are conveyed to the video recorder via the interface means and signals indicating the state of the video recorder are conveyed to the personal computer via the interface means.

### DESCRIPTION OF PREFERRED EMBODIMENTS

Embodiments of the invention will now be described with reference to the drawings in which:

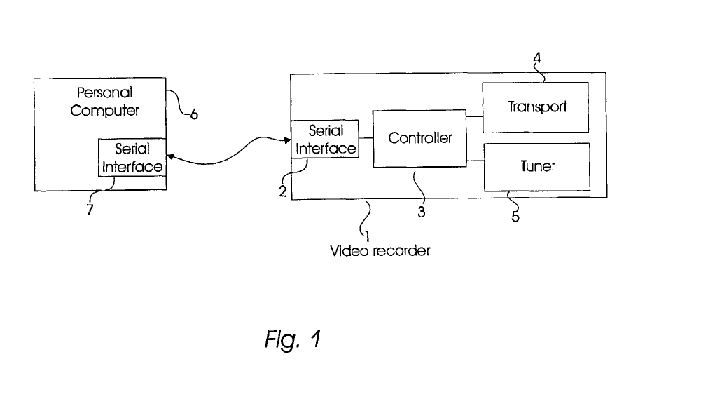

FIG. 1 is a block diagram of an embodiment of the present invention utilizing a personal computer to configure and control a video recorder;

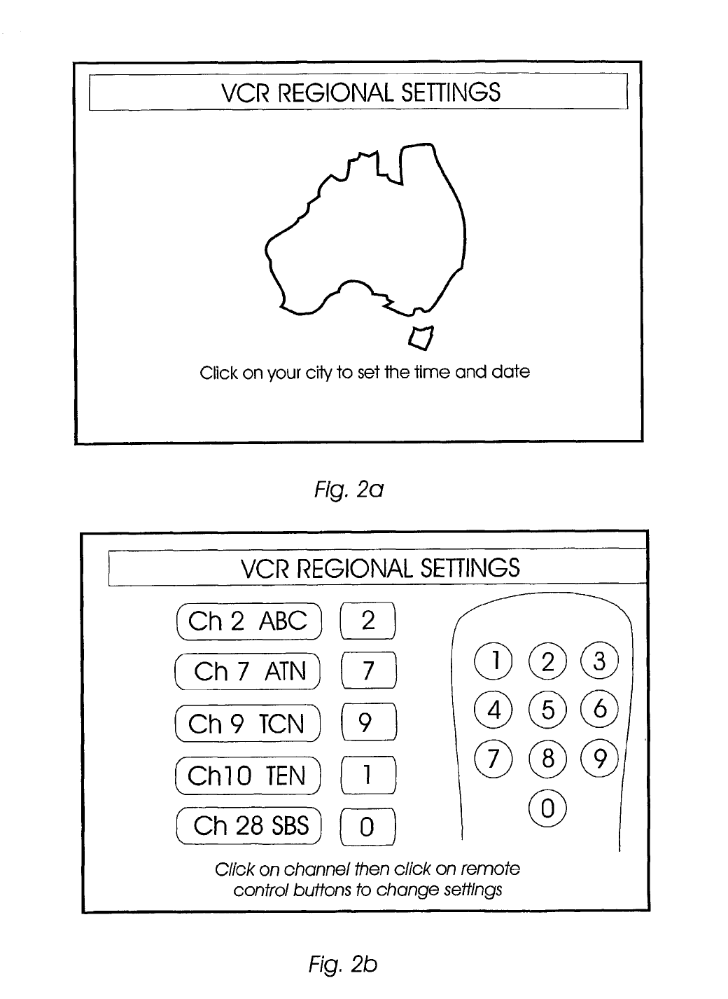

FIG. 2 illustrates how the graphical user interface (GUI) of the personal computer can be used to configure the VCR at installation time;

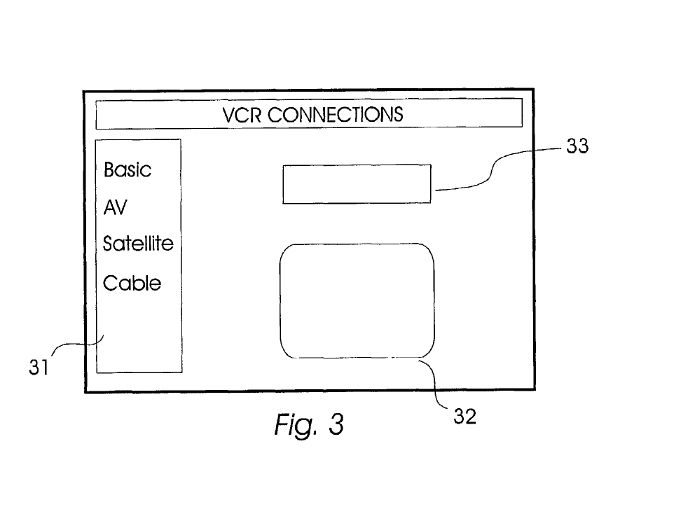

FIG. 3 illustrates how the graphical user interface (GUI) of the personal computer can be used to instruct the owner on VCR connection at installation time;

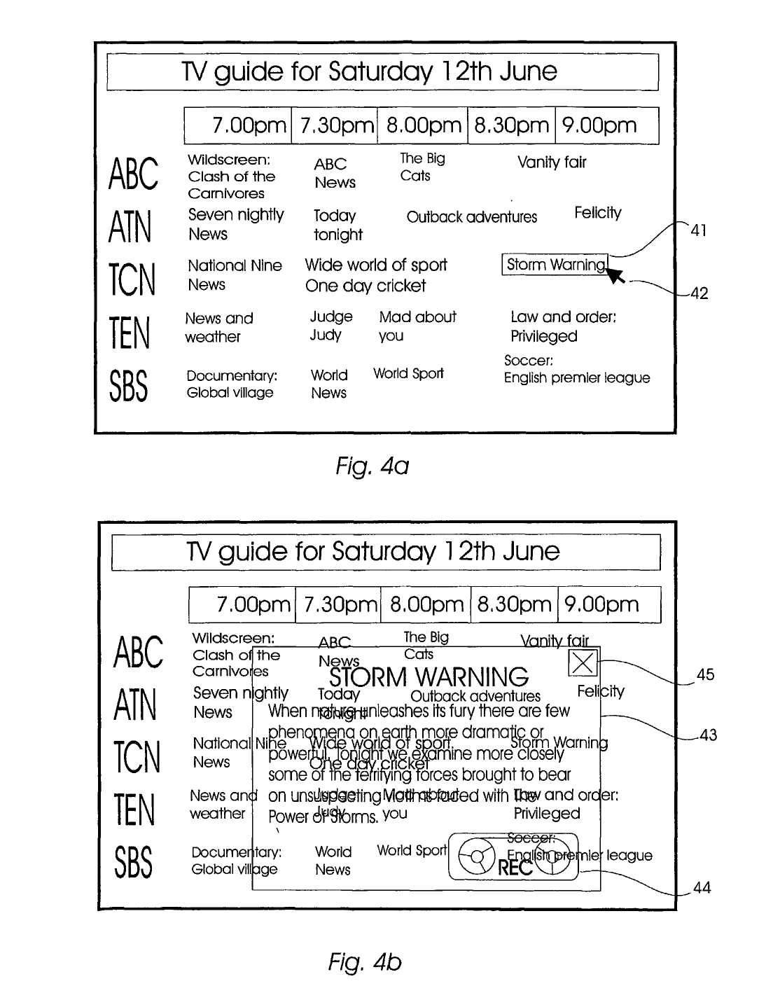

FIG. 4 illustrates how an internet web page displayed by the personal computer can be used to schedule unattended VCR recording; and

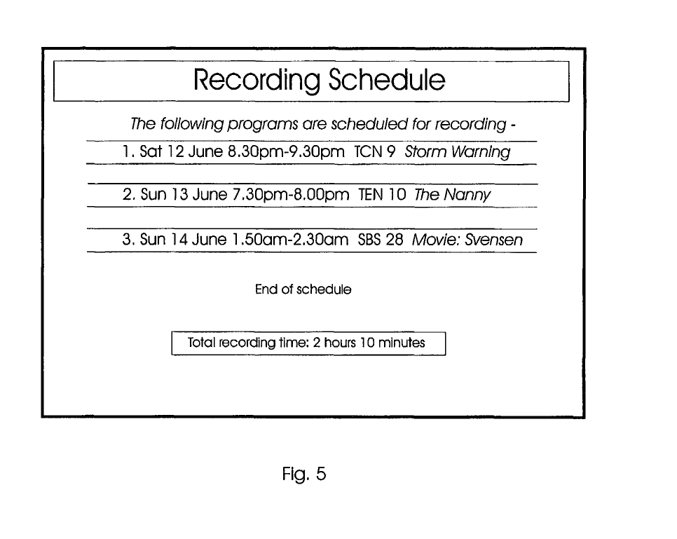

FIG. 5 illustrates how an HTML (hypertext markup language) page displayed on the personal computer can be used to review and edit the unattended VCR recording schedule.

Referring now to FIG. 1, there is shown a block diagram of an embodiment of the invention in which PC 6 is used as the user interface and controller for video recorder 1.

Video recorder 1 comprises a tape (or disk) transport 4, tuner 5 and controller 3 as used in conventional VCRs. In this invention, video recorder 1 also comprises serial interface 2, which enables controller 3 to communicate with an external device, in this case personal computer 6. Personal computer 6 communicates bidirectionally with controller 3 of video recorder 1 via serial interface 7.

Software within controller 3 is arranged so that the following groups of commands are supported—

Read ID: Returns data identifying the make and model of the VCR, firmware revision, individual serial number etc.

Read power: Returns data indicating on, off or standby mode.

Read transport state: Returns status of stop, play, record, pause, fast-forward, rewind.

Read tuner state: Returns channel number, frequency, source selection.

Read media counter: Returns position within tape/disk, time remaining, total time.

Read OSD: Returns contents of on-screen-display memory.

Read configuration memory: Returns contents of non-volatile and volatile configuration memory.

Read tape status: Tape in/out, record protect.

Read schedule: Returns contents of unattended-recording schedule memory

Set power: Sets on, off or standby mode.

Set transport state: Puts transport into stop, play, record, pause, fast-forward, rewind, eject.

Set tuner: Sets tuner channel number, frequency, tuner source selection.

Set source: Select recording source.

Seek: Seeks to position within tape/disk.

Write OSD: Sets contents of on-screen-display memory.

Set configuration memory: Writes data to non-volatile and volatile configuration memory.

Set schedule: Writes contents of unattended-recording schedule memory

Set mode: Standard/long play etc.

Controller 3 also transmits various messages through serial interface 2 in response to certain events within video recorder 1. For example, all data received from the VCR's infra-red remote controller (not shown) is echoed to serial interface 2; depressing any key switches on the control panel of the VCR also results in appropriate messages being sent out the serial port. Any data written to the OSD is also echoed. A message is also sent when a tape reaches the end of playing or spooling. These messages can be used by an external device to ascertain, for example, when the user has changed the channel, switched modes, or invoked a setup menu.

Personal computer 2 is equipped with software which communicates with video recorder 1 to achieve various objects of the invention. This software can be provided with purchase of the VCR, for example in the form of a PC-compatible CDROM. Alternatively, the software can reside in ROM within the VCR and be downloaded to the PC via the serial link. The software can also be provided at a site on the internet.

The functions will now be described with reference to the drawings.

When first setting up the VCR, the owner connects the VCR to the PC using a standard serial interface cable. In this example, the configuration software is accessed from a website, for example http://www.vcrsetup.com. Once this site has been accessed, software within the web page is executed which causes the PC to interrogate the VCR via the serial interface using the Read ID command. The data read from the VCR is then used to take the user to the next web page as appropriate to the model of VCR being configured.

Referring now to FIGS. 2a and 2b, in this example, the first step in configuring the VCR is to establish the regional settings. As seen in FIG. 2a, the owner is presented with a map and invited to click on the area in which they reside. This geographic information is then used to set the clock and calendar of the VCR to the correct time and data for that region. The next web page, devoted to setting the channels for that region, is then loaded. As seen in FIG. 2b, the invention has determined which television channels are available in the region selected, and assigned these to the buttons on the remote controller, shown in diagrammatic form on the web page. In this example, a default allocation has been made whereby the five available channels have been assigned to single digit channel numbers. The appropriate commands have been invisibly sent via the serial interface from the PC to the VCR to establish this channel mapping, as has the frequency for each channel. Normally no other tuning will be required, however if the user wishes to customise the channel settings, this can readily be achieved by using the web-based interface and the PC's mouse or other pointing device.

Further web pages are provided as required to guide the owner through the setup process. For example, FIG. 3 shows a page which instructs the owner on how to connect the VCR to their TV receiver. When the owner selects the type of connection from the choices presented in frame 31, the appropriate cabling appears in graphical form, along with step-by-step instructions.

Troubleshooting is facilitated by the ability of the instructional web pages to interact with the VCR being configured. An intelligent software agent can be provided to experimentally change settings in the VCR to achieve a desired outcome. For example, a troubleshooting page could ask “Do you see the word OKAY on the screen now” and present the owner with yes/no buttons to click, then instruct the VCR to display OKAY on the OSD. A diagnostic tree can thereby be executed to resolve configuration problems.

As well as providing a greatly improved means for configuring the VCR, this embodiment of the invention offers a number of advantageous operational features. Many benefits derive from the provision of a highly user-friendly graphical user interface and from the interaction of the internet and web pages with the video recorder.

One significant benefit of this exemplary embodiment is an interactive TV guide feature which allows the user to view a TV guide and schedule program recording. Referring now to FIG. 4a, a conventional TV guide web page is seen. In this example, the user is interested in finding out more about the program “Storm Warning” and accordingly clicks pointer 42 on the label for this program 41. This causes new window 43 to pop up, as shown in FIG. 4b. This window gives further detail of the program. Unlike prior-art web-based TV guides, this window offers icon 44 which is used to enable recording of the selected program. Clicking on icon 44 causes the channel, time, date and duration information relevant to this program to be downloaded to the unattended-recording memory of the VCR, via the serial interface connection. If further programs are subsequently selected for recording in this way, they are added to the recording schedule in the VCR.

If desired, the provider of the TV guide website can charge for this service, using any of the well-known e-commerce techniques. In such cases, the unique serial number stored in the VCR can be utilised to identify the user, and to enable the service only if the required payment has been made.

Referring now to FIG. 5, another feature of the invention is illustrated. The HTML page of FIG. 5 is a representation of the recording schedule stored in the VCR. This page can be used to view or make changes to the schedule. Using the PC's GUI for this purpose makes unattended recording scheduling much less error-prone and more user-friendly. This display can easily be extended to include further useful information, such as the time remaining until the next recording starts.

In another variant of this embodiment of the invention, control of recording is effected by the PC, rather than by the VCR's recording timer system. In this case, the schedule data is not downloaded to the VCR. Instead, a schedule is built within the PC, and when the program to be recorded is about to start, commands are sent to the PC via the serial interface to select the appropriate tuner source and frequency and place the VCR in record mode. Interrogation of VCR state can be beneficially used to alert the user of various problems, for example if the expected recording time exceeds the time remaining on the recording medium.

The invention can be easily extended to provide a number of real-time control features. For example, rather than using the time and date to start and stop unattended recording, the PC can interrogate a remote server via the internet, radio link or other means to determine the actual starting and finishing moments of the program. In this way the program is correctly recorded in spite of schedule changes.

Similarly, the PC can use remotely-served control data to remove unwanted material from recordings. For example, the VCR can be commanded to pause recording during commercial breaks, or to stop recording if the program contains violent scenes.

The PC can also be used to further enhance the VCR's functions, for example by maintaining a database of which programs have been recorded and keeping track of which tape they are stored on.

The PC and the internet can also be used to automatically generate personalised recording or viewing schedules. For example, a reviewing service can be provided whereby a reviewer sends e-mails to subscribers recommending particular programs to be recorded, and the PC can automatically instruct the VCR to record them.

Other useful functions provided by this exemplary embodiment utilise the VCR's onscreen display capabilities. One such function is the ability to view incoming e-mails. To achieve this, when an e-mail arrives at the PC via the internet, the PC sends a message to the OSD in the VCR to cause an “e-mail waiting” icon to be superimposed on the TV picture. To read an email, the user presses a key on the VCR's remote control. The VCR then sends a message to the PC notifying it of this keypress, and the PC then sends the e-mail text to the VCR's OSD for viewing.

The OSD can also be used for many other features, such as displaying the TV guide on-screen (downloaded from the internet via the PC), or displaying the name, start time and end time of the current program on request.

Another useful feature is the ability to use the OSD to display a “news ticker” along the top or bottom of the TV picture, the contents being selected using a suitable website. This is an attractive way of displaying information such as stock prices, news or weather. The connection with the internet allows for very flexible customisation of such displayed information. For example, the user can request that a message be displayed only if the Microsoft share price falls below a certain figure.

In another extension of this embodiment, the OSD is used to prompt the viewer to respond to sales offers. The words “Press 0 to buy now” appears superimposed on the screen, and if the viewer responds, data is communicated back though the PC to the internet. Similarly, the OSD and remote control can be used to allow the viewer to participate in gameshows. In these examples the VCR's internal unique serial number can be read by the PC and used to identify the respondent.

A wide range of other services can be provided through the use of the OSD, such as reminders of diary appointments, special events etc.

In another extension of the this embodiment, software is provided in the PC to log viewing events. To this end, each time the channel is changed, or a tape is played or recorded, the event and the time of occurrence is stored. This data can then be interrogated remotely for audience research purposes, or for charging on a pay-per-view basis.

It will be understood that certain modifications and extensions of the inventive concept will be obvious to those skilled in the art and can be made without departing from the scope of the present invention.

For example, the invention is applicable to all recording means, including, for example DVD, VCR, and hard-disk based recorders. The invention can also be used for controlling audio recorders.

Whereas the exemplary embodiments described herein use a serial interface, other forms of interface can be utilised with good results, including for example parallel, fibre optic, wireless or infra-red.

1. A video recording system comprising:
recording means;
program tuning means;
a controller adapted to control said recording means and said tuning means;
user interface means comprising a personal computer;
interface means adapted to communicate commands between said controller and said user interface means.

2. A video recording system according to claim 1 wherein said personal computer includes an interface to the Internet.

3.

4. A video recording system according to claim 1 wherein said personal computer is the only means of user interface provided.

5. A video recording system according to claim 2 wherein said personal computer is the only means of user interface provided.

6. A video recording system according to any of claims 1 to 4 in which said commands include commands which control said program tuning means.

7. A video recording system according to any of claims 1 to 4 further comprising onscreen display means for generating a video signal representative graphical symbols, and in which said commands include commands which cause said onscreen display means to display said symbols.

8. A video recording system according to claim 6 in which said displayed symbols comprise information about a program being recorded or viewed.

9. A video recording system according to claim 6 in which said displayed symbols comprise at least a portion of an email-message received by said personal computer.

10. A video recording system according to claim 2 or 4 in which said personal computer is further adapted to receive web pages from a remote server connected to said Internet.

11. A video recording system according to any of claims 1 to 4 in which said commands include commands which cause said controller to return information to said personal computer identifying a hardware model or software revision.

12. A video recording system according to any of claims 1 to 4 in which said commands include commands which cause said controller to return a message to said personal computer indicating operational states including at least one of: on, off, standby, pause, stop, play record, fast-forward, rewind, recording medium inserted, recording medium not inserted, recording medium full.

13. A video recording system according to any of claims 1 to 4 in which said commands include commands which cause said controller to return a message to said personal computer representing the contents of an unattended-recording schedule.

14. A video recording system according to any of claims 1 to 4 in which said commands include commands which cause said controller to return a message to said personal computer indicating the current operating parameters of said program tuning means.

15. A video recording system according to claim 9 in which said personal computer is further adapted to configure said controller according to information obtained by interaction with said web pages.

16. A video recording system according to claim 14 in which said configuration includes setting a clock.

17. A video recording system according to claim 14 in which said configuration includes establishing a mapping between channel numbers and frequencies.

18. A video recording system according to any of claims 1 to 4 in which said personal computer includes a pointing device and provides a graphical representation of recording controls and, according to user input via said pointing device, sends commands to said controller.

19. A video recording system according to claim 9 in which said web pages include a step-by-step guide which instructs a user in configuring said video recorder.

20. A video recording system according to claim 9 in which said web pages include a program guide and said personal computer further includes a pointing device and is adapted to send commands to said controller to cause scheduling of unattended recording of programs according to user manipulation of said pointing device.

21. A video recording system according to claim 9 in which said web pages include a program guide and said personal computer further includes a pointing device and is further adapted to:
receive user selection of programs according to program titles selected by a user from said web page program guide;
receive a signal from the Internet indicating which programs are currently being broadcast; and
when said indicating signal indicates that broadcast of one of said program titles is commencing, send commands to said controller to set the channel tuned by said program tuning means and to start recording.

22. A video recorder comprising recording means, program tuning means, an onscreen display generator, and interface means adapted to receive commands from an external source, wherein:
said received commands include commands which cause said on-screen display generator to generate messages.

23. A video recorder according to claim 22 in which said generated messages are strings of text characters.

24. A video recorder comprising recording means, program tuning means, an onscreen display generator, and interface means adapted to receive commands from an external source, wherein:
said received commands include commands which configure said program tuning means.

25. A video recorder comprising recording means, program tuning means, an onscreen display generator, and interface means adapted to receive commands from an external source and to send data to an external destination, wherein:
said received commands include interrogation commands which cause said interface to send data to an external destination said data representing the configuration of said program tuning means.

26. A video recorder comprising recording means, program tuning means, recording schedule memory, and interface means adapted to receive commands from an external source, wherein:
said received commands include commands which configure said program recording schedule memory.

27. A video recorder comprising recording means, program tuning means, recording schedule memory, and interface means adapted to receive commands from an external source and to send data to an external destination, wherein:
said received commands include interrogation commands which cause said interface to send data to an external destination said data representing the configuration of said recording schedule memory.

28. A video recorder substantially as hereinbefore described, with reference to the accompanying drawings.
